(19) United States
(12) Patent Application Publication
(10) Pub. No.: US 2013/0244475 A1
(43) Pub. Date: Sep. 19, 2013

(54) WALL OUTLET WITH RETRACTABLE USB CHARGING CABLE CONNECTED TO A USB PORT WITHIN A WALL

(71) Applicants: Hamid Sayadi, San Diego, CA (US); Rodolfo Garza, San Ysidro, CA (US)

(72) Inventors: Hamid Sayadi, San Diego, CA (US); Rodolfo Garza, San Ysidro, CA (US)

(21) Appl. No.: 13/423,011

(22) Filed: Mar. 16, 2012

(51) Int. Cl. H01R 11/01; H01R 43/00; H01R 13/72

(52) U.S. Cl. 439/501; 439/502; 29/825

(57) ABSTRACT

The present invention relates to a system, method, and apparatus for charging electronics with a universal serial bus (USB) charging cable connected to a USB port. The USB port is located entirely behind a wall having a wall outlet. The USB charging cable and its connectors can easily be retracted into the wall for storage or extended outside the wall to a USB powered device. A plurality of USB charging cables can be installed in one wall outlet, such as one USB charging cable having a Micro-USB plug and one USB charging cable having an Apple 30 pin connector. The wall outlet can also have an AC outlet as well, such that the wall outlet can charge most electronic devices sold in the market today. The wall outlet allows the user to charge USB powered devices even when the user does not have his USB cord with him.

### BACKGROUND OF THE INVENTION

1. Field of Invention

The present invention relates generally to a wall outlet and specifically to a method, apparatus, and system for charging universal serial bus (USB) powered electronics with a retractable USB charging cable connected to a USB port within a wall.

2. Description of Related Art

All residential buildings have wall outlets for powering electronic devices such as lights, appliances, computers, and mobile devices. A wall outlet is sometimes referred to as an alternating current (AC) wall charger because most conventional wall outlets charge AC powered devices. The AC powered devices have a power cord with a plug configured to be connected to and removed from the wall outlet. Although most conventional wall outlets only include AC outlets, nowadays wall outlets also provide power connections to both AC and USB powered devices through an AC outlet and a USB port. This is because nowadays, many electronics including phones, cameras, camcorders, can connect to power via a USB port.

An outlet is a female connector with slots or holes in the wall outlet. The slots are configured to receive a male connector often referred to as a plug. The plug has protruding prongs, blades, or pins that fit into matching slots in the wall outlet. The wall outlet is enclosed by a cover typically called a wall plate, face plate, outlet cover,—socket cover, or wall cover. Different countries have different national standards for wall outlets. The national standards differ by voltage rating, current rating, connector shape, connector size, and connector type.

Most devices sold today, including cell phones, cameras, camcorders, include a USB charging cable that terminates with a common USB plug on one end. To minimize the number for chargers and power supplies for the large variety of devices sold in the market, the Micro-USB plug has become a standard input connector to most devices except the Apple products. Apple uses its own proprietary 30-pin connector that is common among all Apple products and can be licensed from Apple free of charge upon request.

However, a problem with conventional wall outlets is that the user must have his USB charging cable in order to connect to the USB port. If the user is travelling and forgets his USB charging cable, the USB port in the conventional wall outlet is useless. Even if the user decides to use the AC outlet instead, the user still needs the USB charging cable, along with an adaptor that is part of the device's charger. So, if the user loses or forgets his USB charging cable, it would be impossible for him to charge his USB powered devices. Similarly, if the user's USB charging cable is not easily available, such as being located upstairs, in the car, or in another room, the user cannot use the conventional wall outlet until the USB charging cable is obtained.

U.S. Pat. No. 7,857,659 to Wang is directed to a notebook computer USB port extender. An extending connecting cable is added to the USB port on the electronic device. In a normal condition, the connecting cable is accommodated in a cable reel to make the USB port accommodated in an accommodating recess of the electronic device to keep consistency of the appearance. In a using condition, the USB port may be taken out and used in a needed place by drawing out the connecting cable. This overcomes the disadvantage that the conventional adjacent USB ports may be interfered with each other, and the scope of use also increases.

U.S. Patent Pub. No. 2011/0215759 to Lee is directed to a detachable electrical power port extension cord. The extension cord has a detachable electrical power port which comprises: a main body; an extension socket for receiving and supplying an electrical power; and an extension power cord, being connecting between the extension socket and the main body. The detachable electrical power port includes a coil reel for winding the extension power cord. Whereby, the length of the extension power cord is adjustable so as to control the extension socket to be disengaged from the main body in an exposed mode or engaged to the main body in a concealed mode, so that the inconvenience by applying additional charging connectors and the extension power cords thereof to charge electronic devices may be reduced.

U.S. Pat. No. 6,648,677 to Boyd is directed to a wiring outlet with a retractable extension cord mechanism. The wiring outlet assembly having a fixed wiring outlet and a moveable wiring outlet socket member adapted to seat within a cavity of the assembly and removably positionable from the cavity; the removable outlet socket member being electrically connected to an extension cord in electrical connection with the fixed wiring outlet and having a retraction system for retractably extending the wiring outlet socket member a desired distance so that a user may readily connect a connector plug of a device, such as a power plug or phone jack plug, without searching for an extension cord.

However, Wang, Lee, and Boyd do not eliminate the need for a USB charging cable. This is because none of these devices provide a USB charging cable. Wang and Lee provide a USB ports, but a USB port is of no use to a user who does not have his USB charging cable. Further, Wang and Lee are not even wall outlets and cannot be hidden behind a wall containing the wall outlet.

### SUMMARY OF THE INVENTION

Embodiments of the present invention relate to a system, method, and apparatus for charging electronics with a universal serial bus (USB) charging cable connected to a USB port. The USB port is located entirely behind a wall having a wall outlet. The USB charging cable and its connectors can easily be retracted into the wall for storage or extended outside the wall to a USB powered device. A plurality of USB charging cables can be installed in one wall outlet, such as one USB charging cable having a Micro-USB plug and one USB charging cable having an Apple 30 pin connector. The wall outlet can also have an AC outlet as well, such that the wall outlet can charge most electronic devices sold in the market today. The wall outlet allows the user to charge USB powered devices even when the user does not have his USB cord with him.

In one embodiment, a system comprises: a first USB port within a wall; a first USB powered device; a first USB charging cable at least partially within the wall, the first USB charging cable connected the USB port, the first USB charging cable configured to extend outside the wall to connect to the first USB powered device; and a wall outlet on the wall, the wall outlet configured to provide power to the first USB powered device. The first USB charging cable may be retractable. The system may further comprise a second USB charging cable and a second USB powered device. The first USB charging cable may comprise an Apple connector and the second USB charging cable may comprise a Micro-USB plug. The first USB powered device may comprise an Apple device and the second USB device may comprise a Blackberry device. One end of the first USB charging cable may comprise a USB plug and the other end of the first USB charging cable may comprise a Micro-USB plug or an Apple connector. The Apple connector may comprise a 30 pin connector. The USB plug may connect to the first USB port. The wall outlet may further comprise an AC outlet, a slot configured for the first USB charging cable to slide through, and a power supply.

In another embodiment, an apparatus comprises: a first USB port within a wall; a first USB charging cable at least partially within the wall, the first USB charging cable connected the USB port, the first USB charging cable configured to extend outside the wall to connect to a first USB powered device; and a wall outlet on the wall, the wall outlet configured to provide power to the first USB powered device. The first USB charging cable may be retractable. The apparatus may further comprise a second USB charging cable and a second USB powered device. The first USB charging cable may comprise an Apple connector and the second USB charging cable may comprise a Micro-USB plug. The first USB powered device may comprise an Apple device and the second USB device may comprise a Blackberry device.

In a further embodiment, a method comprises the steps of: providing a first USB port within a wall; connecting a first USB charging cable to the first USB port, the first USB charging cable configured to extend outside the wall to connect to a first USB powered device; and providing power to the first USB powered device using a wall outlet on the wall. The first USB charging cable may be retractable. The method may further comprise a second USB charging cable and a second USB powered device. The first USB charging cable may comprise an Apple connector and the second USB charging cable may comprise a Micro-USB plug.

An advantage of the present invention is that the system allows a user to charge his USB powered device even if the user does not have his original USB charger cord or adapter that came along with the USB powered device's charger. The user no longer needs to remember, bring, or have his USB cable. The USB cable can be forgotten, lost, misplaced, broken, in use by another, or simply located in another room. Alternatively, the user may have brought the wrong device charger. When the user is traveling at a hotel with the wall charging system, the user no longer needs to worry about packing, forgetting, breaking, or losing his USB charging cable. When the user is at home with the wall charging system, the user can charge his devices from any room without having to get the USB charging cable or the original charger which may be in the car or upstairs.

Another advantage of the present invention is that almost all of the parts of the wall charging system are located within the wall. For example, the USB port and at least a portion of the USB cable remains hidden behind the wall producing a cleaner look, reducing clutter, and saving space such that objects such as a desk, couch, or television can be placed adjacent to the wall.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 illustrates a wall charging system according to one embodiment of the invention.

FIG. 2 illustrates an enlarged view of a USB charging cable of the charging system according to one embodiment of the invention.

FIG. 3 illustrates an enlarged view of a controller and USB port of the charging system according to one embodiment of the invention.

FIGS. 4-5 illustrates a view outside of a non-AC wall charging system on a wall according to one embodiment of the invention.

FIG. 6 illustrates a flow chart showing a process for connecting a USB powered device to a power supply within a wall outlet according to one embodiment of the invention.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

In the market today, there are wall outlets with USB plugs that provide the USB power necessary to charge these devices as long as the user has his own cable. However, the wall outlet of the present invention is novel because it totally eliminates the need for all peripherals for charging a handheld or other USB device that accepts a Micro-USB plug or an Apples 30-pin connector. The user does not need to have his own USB cable, adapter, charger, or power supply. The wall outlet has an integrated USB cable that mates directly to the user's USB device by either a Micro-USB plug and/or an Apple 30-pin connector. As such, the wall outlet with integrated USB charge circuitry is capable of charging most devices sold in the market today. The connector and the cable can easily be retracted into the wall outlet for storage. The wall outlet can have both the Micro-USB plug and Apple's 30-pin connector on the receptacle. Additionally, the wall outlet can have an AC outlet as well. Although the invention is sometimes illustrated and described in the context of a 30 pin Apple connector, one of ordinary skill in the art can apply these concepts in other USB connectors.

With the wall outlet, the user can fully charge his device by attaching it to the wall outlet without needing his USB cable. All of the charge circuitry including the connector to the user's device is integrated into the wall outlet. The wall outlet makes life easier for everyday users because it is very common for a user to need to charge his USB powered device, however, the charger that came with the user's device is somewhere else. With this wall outlet in one or all locations of the user's home, office, hotel room, airport, coffee lounge and restaurant, the user does not need to worry about lugging his only charger and cable around to multiple spots. Further, the charger does not need to take up valuable space in the user's briefcase, luggage, or backpack.

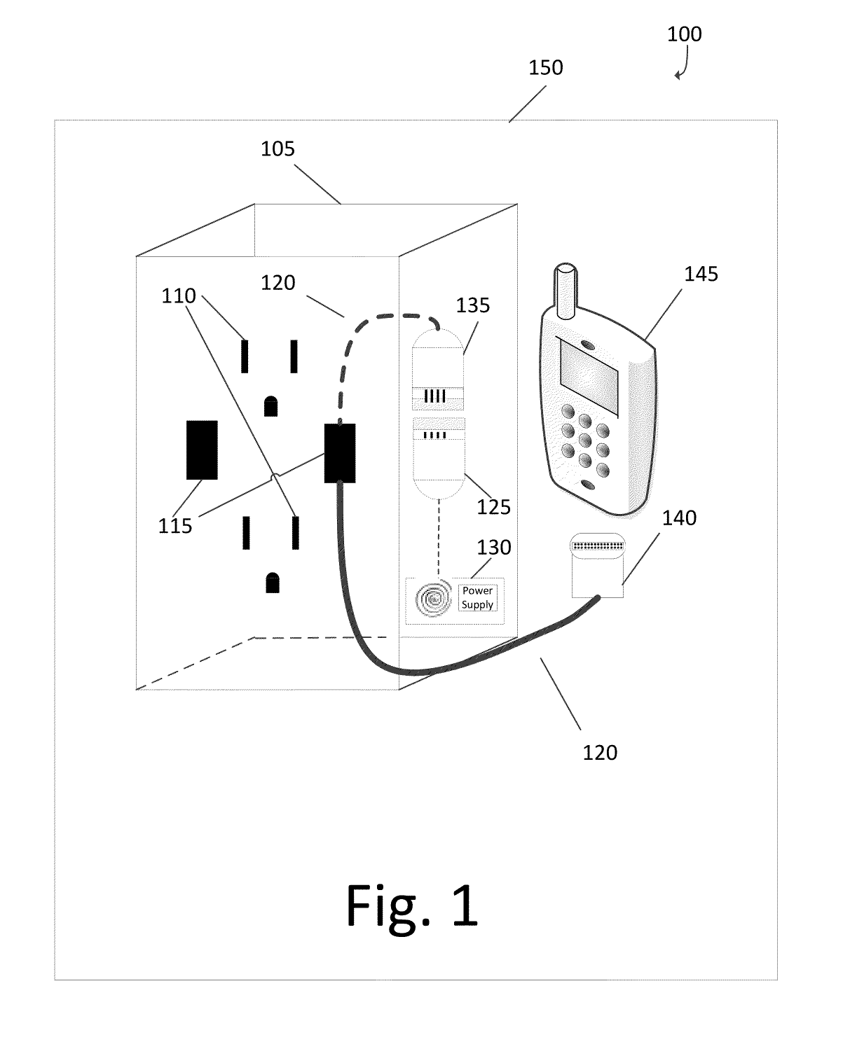

FIG. 1 illustrates a wall charging system 100 according to one embodiment of the invention. The charging system 100 includes a wall 150, a wall outlet 105 having one or more AC outlets 110, one or more slots 115, a USB port 125, a controller 130, a USB charging cable 120 having a USB plug 135 and a device connector 140, and a USB powered device 145. The charging system 100 hides the USB port 125 entirely behind the wall 150 and hides at least a portion of the USB charging cable 120 behind the wall 150. The charging system 100 eliminates the need for the user to have the device's USB charger, USB cable, and adaptor readily available for charging the USB powered device 145.

When the wall outlet 105 is in use, the USB charging cable 120, which is at least partially within the wall 150, extends through one of the slots 115 of the wall outlet 105 and connects to the USB powered device 145. When the wall outlet 105 is not in use, it stores the USB charging cable 120 within one of the slots 115 of the wall outlet 105 in the wall 150. The wall outlet 105 may also be referred to as a wall charger, a USB outlet, an AC/USB outlet, a power outlet, an electrical outlet, a socket, a wall mounted socket, a port, an outlet, a point power, etc.

The AC outlets 110 are on the face of the wall outlet 105. The AC outlets 110 are conventional female connectors for charging electronic devices requiring AC input. Most homes and buildings currently use wall outlets having only AC outlets.

The slots 115 are also on the face of the wall outlet 105. The slots 115 allow the USB charging cable 120 to slide through the wall outlet 105 such that the USB charging cable 120 can be both accessed externally and stored internally. The size of the slots 115 can be designed according to the size of the device connector 140 selected to fit within a particular slot 115.

The USB charging cable 120 (e.g. USB cable, USB cord, USB power cable, USB charging cable, mating cable/connector, etc.) has the USB plug 135 on one end and the device connector 140 on the other end. The USB charging cable 120 can be retracted within the wall 150 and also extended outside the wall 150 to the USB powered device 145. At least a portion of the USB charging cable 120 is within the wall 150 when in use.

The illustrated USB charging cable 120 has dotted lines to convey the portion of the USB charging cable 120 located behind the wall 150. The USB charging cable 120 operates the same as the user's USB cable that he obtained along with the power adapter when he purchased the USB powered device 145. As such, the user does not need to have his own charger or cable to charge the USB powered device 145. The user no longer needs to remember, bring, or have his USB cable with him. The USB charging system 100 works even if the user's USB cable is forgotten, lost, misplaced, broken, in use by another, or simply located in another room.

The USB port 125 (e.g., USB receptacle, connector, terminal, etc.) is a conventional female connector for charging USB powered devices. The USB port 125 is hidden behind the wall 150 regardless whether the wall charging system 100 is in use or not. The USB port 125 connects to USB plug 135 of the USB charging cable 120.

The controller 130, also within the wall 150, includes a power supply and retractable cable apparatus. The power supply charges the USB powered device 145. The retractable cable apparatus allows the USB charging cable 120 to slide through the wall outlet 105 on the wall 150.

The USB plug 135 (e.g., a USB male connector, USB male circuit contact, etc.) is a conventional connector that plugs into the USB port 125. The USB plug 135 is within the wall, hidden from the user's viewpoint, which saves space and creates a cleaner looking wall outlet 105.

The device connector 140 connects to the USB powered device 145. In one embodiment, the device connector 140 is a Micro-USB plug. In another embodiment, the device connector 140 is an Apple 30 pin connector. In a further embodiment, the wall outlet 105 uses both slots 115, one slot 115 for the Apple connector and one slot 115 for the Micro-USB plug.

The USB powered device 145 includes all USB powered devices including, but not limited to, cell phones, cameras, and camcorders. The USB powered device 145 can be an Apple product, such as an iPhone. The USB powered device 145 can be a Blackberry smartphone. One of ordinary skill in the art appreciates that the USB powered devices 145 are not limited to these listed embodiments.

The wall 150 provides the structure for the wall outlet 105. The wall also hides most of the parts of the wall charging system 100. In one embodiment, the wall 150 is a structural piece of a building. In another embodiment, the wall is a portion of equipment such as a power supply.

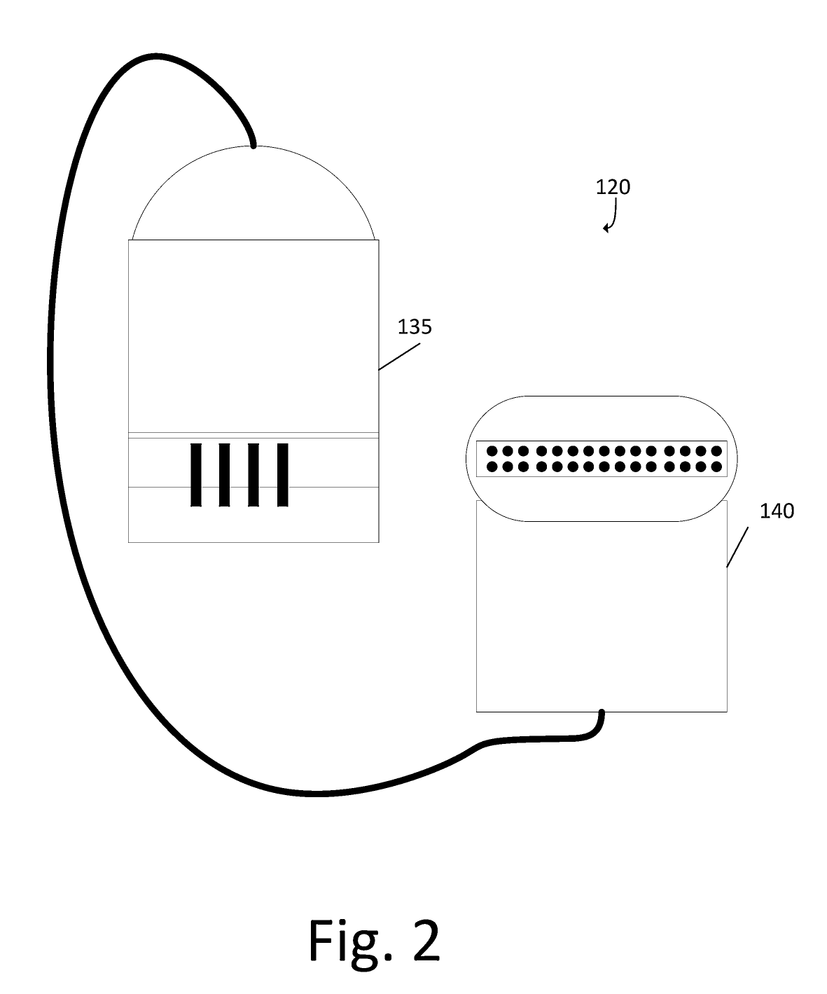

FIG. 2 illustrates an enlarged view of the USB charging cable 120 of the charging system 100 according to one embodiment of the invention. The USB charging cable 120 is provided such that the user does not need to provide bring, remember, or retrieve the original USB charging cable provided with the USB powered device 145. The USB plug 135 is a male connector and the device connector 140 is a 30 pin male connector. In another embodiment, the device connector 140 is a Micro-USB plug or another USB connector. The USB plug 135 is configured to plug into the USB port 125. The device connector 140 is configured to plug into the USB powered device 145.

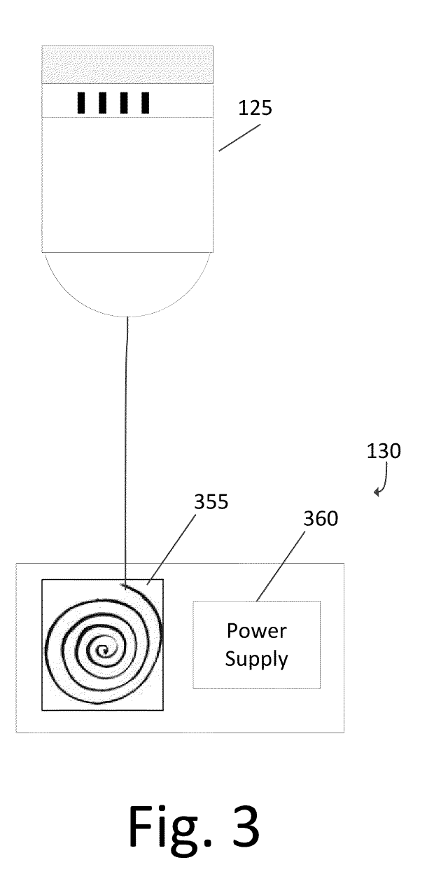

FIG. 3 illustrates an enlarged view of the controller 130 and the USB port 125 of the charging system 100 according to one embodiment of the invention. The controller 130 includes a retractable cable apparatus 355 and a power supply 360. The retractable cable apparatus 355 allows the device connector 140 to extend further through the slots 115 of the wall outlet 105 to reach the USB powered device 145 when the wall charging system 100 is in use and allows the device connector 140 to retract within the wall 150 when the wall charging system 100 in not in use. The power supply 360 provides power to the USB powered device 145.

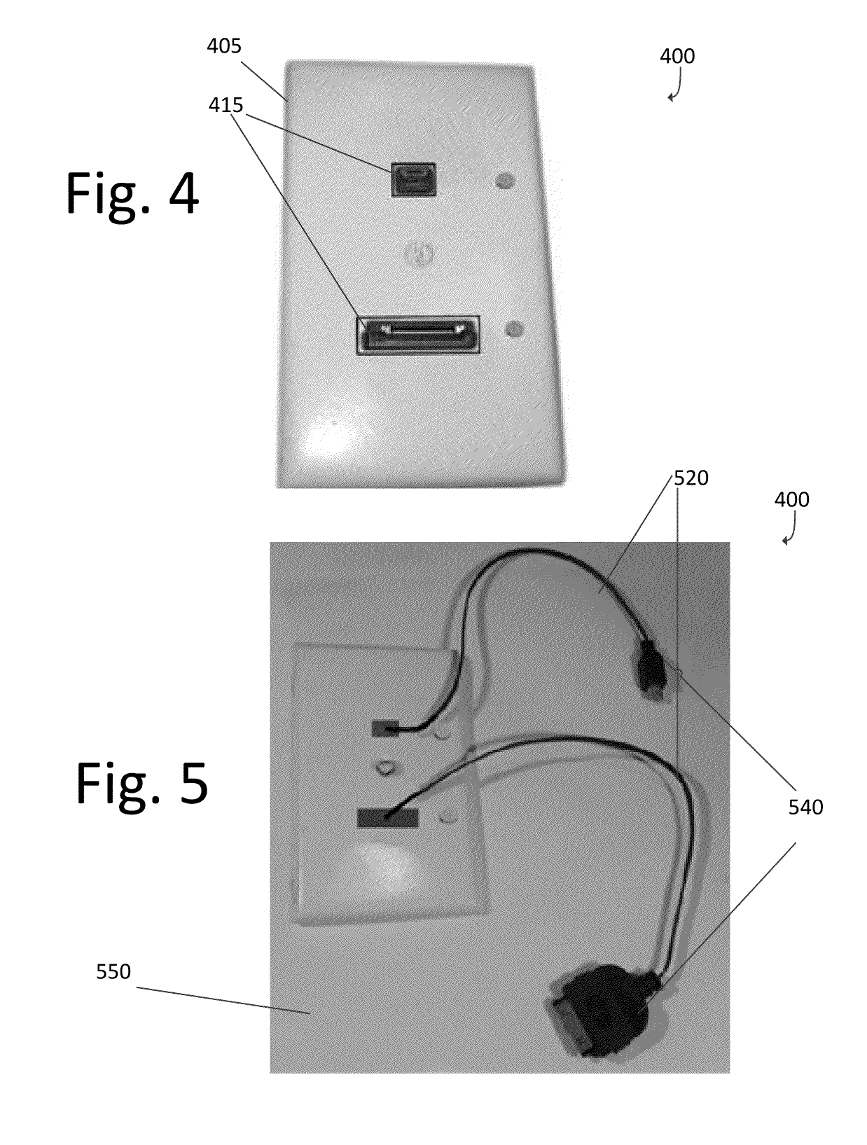

FIGS. 4-5 illustrates a view outside of a non-AC wall charging system 400 on a wall 550 according to one embodiment of the invention. The system 400 includes a wall outlet 405 with slots 415, a USB charging cable 520 having a plurality of device connectors 540. The slots 415 are sized such that the device connectors 540 can fit within. Unlike the wall charging system 100, the system 400 does not include the AC outlets 110. Further, the system 400 is illustrated from a view outside of the wall 550, which only shows the device connector 540 and a portion of the USB charging cable 520, as the rest of the parts (e.g., a USB port, a portion of the USB charging cable 520, a USB plug, a power supply, a retractable cable apparatus, a controller, etc.) are hidden behind the wall 550.

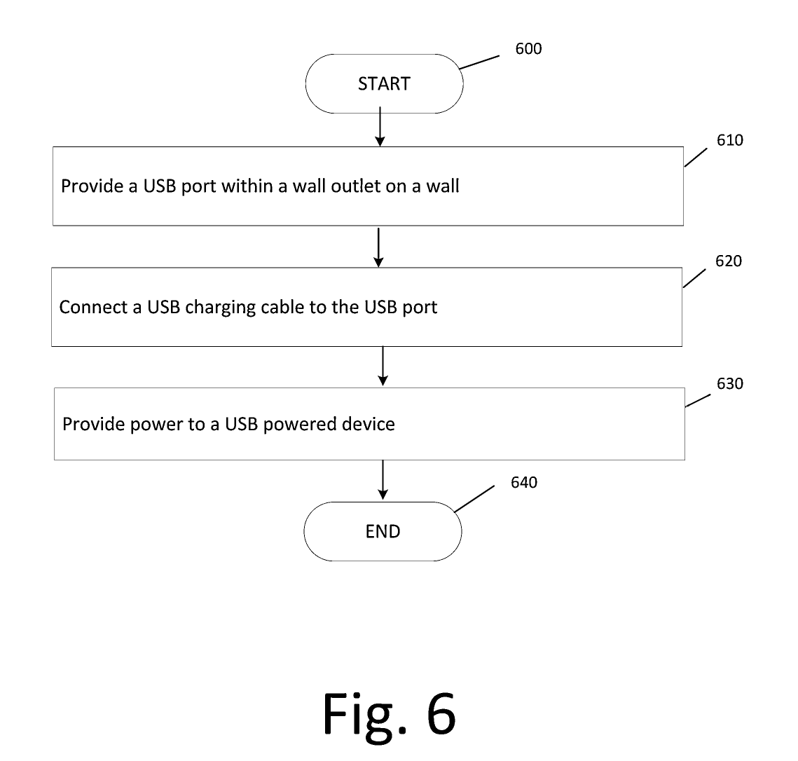

FIG. 6 illustrates a flow chart showing a process for connecting the USB powered device 145 to the power supply 360 within the wall 150 according to one embodiment of the invention. The process starts at step 600. At step 610, the charging system 100 provides the USB port 125 within the wall 150. Next, at step 620, the charging system 100 connects the USB charging cable 120 to the USB port 125. The USB charging cable 120 can be retractable such that it can extend and retract through the slots 115 of the wall outlet 105. At step 630, the charging system 100 provides power to the USB powered device 145. The USB powered device 145 can be an Apple iPhone, a Blackberry smartphone, a camera, or any other USB powered device. The process ends at step 640.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

It should be understood that the invention is not limited to the embodiments set forth herein for purposes of exemplification, but is to be defined only by a fair reading of the appended claims, including the full range of equivalency to which each element thereof is entitled. Although the invention has been described with reference to the above examples, it will be understood that modifications and variations are encompassed within the spirit and scope of the invention. Accordingly, the invention is limited only by the following claims.

What is claimed is:

1. A system comprising:
a first USB port within a wall;
a first USB powered device;
a first USB charging cable at least partially within the wall, the first USB charging cable connected the USB port, the first USB charging cable configured to extend outside the wall to connect to the first USB powered device; and
a wall outlet on the wall, the wall outlet configured to provide power to the first USB powered device.

2. The system of claim 1, wherein the first USB charging cable is retractable.

3. The system of claim 1, further comprising a second USB charging cable and a second USB powered device.

4. The system of claim 3, wherein the first USB charging cable comprises an Apple connector and the second USB charging cable comprises a Micro-USB plug.

5. The system of claim 3, wherein the first USB powered device comprises an Apple device and the second USB device comprises a Blackberry device.

6. The system of claim 1, wherein one end of the first USB charging cable comprises a USB plug and the other end of the first USB charging cable comprises a Micro-USB plug or an Apple connector.

7. The system of claim 6, wherein the Apple connector comprises a 30 pin connector.

8. The system of claim 6, wherein the USB plug connects to the first USB port.

9. The system of claim 1, wherein the wall outlet further comprises an AC outlet.

10. The system of claim 1, wherein the wall outlet comprises a slot configured for the first USB charging cable to slide through.

11. The system of claim 1, wherein the wall outlet comprises a power supply.

12. An apparatus comprising:
a first USB port within a wall;
a first USB charging cable at least partially within the wall, the first USB charging cable connected the USB port, the first USB charging cable configured to extend outside the wall to connect to a first USB powered device; and
a wall outlet on the wall, the wall outlet configured to provide power to the first USB powered device.

13. The apparatus of claim 12, wherein the first USB charging cable is retractable.

14. The apparatus of claim 12, further comprising a second USB charging cable and a second USB powered device.

15. The apparatus of claim 14, wherein the first USB charging cable comprises an Apple connector and the second USB charging cable comprises a Micro-USB plug.

16. The apparatus of claim 14, wherein the first USB powered device comprises an Apple device and the second USB device comprises a Blackberry device.

17. A method comprising:
providing a first USB port within a wall;
connecting a first USB charging cable to the first USB port, the first USB charging cable configured to extend outside the wall to connect to a first USB powered device; and
providing power to the first USB powered device using a wall outlet on the wall.

18. The method of claim 17, wherein the first USB charging cable is retractable.

19. The method of claim 17, further comprising a second USB charging cable and a second USB powered device.

20. The method of claim 19, wherein the first USB charging cable comprises an Apple connector and the second USB charging cable comprises a Micro-USB plug.
